(19) United States
(12) Patent Application Publication
(10) Pub. No.: US 2012/0265579 A1
(43) Pub. Date: Oct. 18, 2012

(54) ENABLING A SUPPLIER OF COMPUTING INFRASTRUCTURE TO ANALYZE AN ASPECT OF BUSINESS

(76) Inventors: Richard Shaw Kaufmann, San Diego, CA (US); Dejan S. Milojicic, Palo Alto, CA (US)

(21) Appl. No.: 13/418,965

(22) Filed: Mar. 13, 2012

Related U.S. Application Data
(60) Provisional application No. 61/476,509, filed on Apr. 18, 2011.

(51) Int. Cl. G06Q 10/06

(52) U.S. Cl. 705/7.28

(57) ABSTRACT

A supplier of computing infrastructure is enabled to analyze an aspect of business with respect to cloud computing business users of the computing infrastructure. A model for a cloud computing business for the cloud computing business users to rent computing items of the computing infrastructure from the supplier is accessed. The model includes inputs, parameters, and knobs. Sensitivity analysis and risk assessment are performed using the model based on any of the inputs, parameters, and knobs. Output describing results of the sensitivity analysis and the risk assessment is provided.

### RELATED APPLICATIONS

This application claims priority to the copending U.S. Provisional Patent Application 61/476,509, entitled “IaaS Business Technology Modeling (IBTM)” with the filing date of Apr. 18, 2011, by Richard S. Kaufmann et al., which is herein incorporated by reference in its entirety.

### BACKGROUND

With the advent of computer systems, business owners typically bought and managed their own computing infrastructure. However, since the utilization of their computing infrastructure can change drastically over a period of time for many businesses, it has become more effective for businesses to rent computing infrastructure when their demand increases so that their capital is not tied up in a large amount of computing infrastructure that is not used for significant amounts of time. Examples of computing items that are a part of the computing infrastructure include, among other things, storage, bandwidth, computing power, software that executes on hardware.

In response to this, new business opportunities have emerged for companies to become suppliers of computing infrastructure that other businesses can rent (referred to herein as “renters,” “renting businesses,” or “business users”). The supplier's computing infrastructure may be associated with data centers that are distributed around the world that are unknown or invisible to renting businesses. Further the renting businesses, as well as any data centers that they may have, may also be located any where around the world. Cloud computing business refers to the distributed nature of the supplier's data centers and the distributed locations of the renting businesses, among other things.

### BRIEF DESCRIPTION OF THE DRAWINGS

The accompanying drawings, which are incorporated in and form a part of this Description of Embodiments, illustrate various embodiments of the present invention and, together with the description, serve to explain principles discussed below:

FIG. 1 is a block diagram of a model, according to one embodiment.

FIG. 2 is a block diagram depicting a generalized use case of the model, according to one embodiment.

FIG. 3 is a block diagram of a system that enables a supplier of computing infrastructure to analyze an aspect of business with respect to cloud computing business users of the computing infrastructure, according to one embodiment.

FIG. 4 is a block diagram of a cloud computing business architecture that includes a system that enables a supplier of computing infrastructure to analyze an aspect of business with respect to cloud computing business users of the computing infrastructure, according to one embodiment.

FIG. 5 depicts a flow chart for a number of uses of the system, according to one embodiment.

FIG. 6 depicts an example of a closed loop network effect e.g., peering, according to one embodiment.

FIG. 7 depicts a flow chart of a method of enabling a supplier of computing infrastructure to analyze an aspect of business with respect to cloud computing business users of the computing infrastructure.

FIG. 8 depicts one example of output, according to one embodiment.

The drawings referred to in this Brief Description should not be understood as being drawn to scale unless specifically noted.

### DESCRIPTION OF EMBODIMENTS

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in the following description of embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Unless specifically stated otherwise as apparent from the following discussions, it is appreciated that throughout the description of embodiments, discussions utilizing terms such as “accessing,” “performing,” “providing,” “obtaining,” “enabling,” “receiving,” “outputting,” “computing,” “specifying,” “describing,” “managing,” “controlling,” “evaluating,” “forecasting,” “mitigating,” “monitoring,” “provisioning,” “re-provisioning,” “looping,” “actuating,” “detecting,” “determining,” “operating,” “using,” “accessing,” “messaging,” “transitioning,” “comparing,” “associating,” “requesting,” “deleting,” “receiving,” “transmitting,” “communicating,” “creating,” “obtaining,” “executing,” “storing,” “detecting,” “causing,” “transforming data,” “modifying data to transform the state of a computer system,” or the like, refer to the actions and processes of a computer system, data storage system, storage system controller, microcontroller, computer processor, or similar electronic computing device or combination of such electronic computing devices. The computer system or similar electronic computing device manipulates and transforms data represented as physical (electronic) quantities within the computer system's/device's registers and memories into other data similarly represented as physical quantities within the computer system's/device's memories or registers or other such information storage, transmission, or display devices.

It can be difficult to manage computing infrastructures, for example, because it is difficult to anticipate demand. For example, certain types of businesses are not tied to using computing infrastructure at any specific time. They can wait until the demand for the supplier's computing infrastructure is low to rent computing items at a bargain. For similar reasons, it can be difficult for the supplier to determine how to modify pricing of the computing items based on perceived demand, and when and how much computing infrastructure to build, among other things. As with most businesses, typically one of the supplier's goals may be to build the computing infrastructure so as to optimize revenue and profits.

A method and a system are provided that enable a supplier of computing infrastructure to, for example, analyze an aspect of business with respect to cloud computing business users of the computing infrastructure in order to address the difficulties of anticipating demand for computing infrastructure, determining how to modify pricing of the computing items, or determining when and how much computing infrastructure to build, or a combination there of, among other things, according to various embodiments.

A set of inputs, parameters, knobs and outputs that model the cloud computing business can be determined. Sensitivity analysis and risk assessment can be performed using the model based on any of the parameters of the model. Output that describes results of the sensitivity analysis and the risk assessment can be provided. The supplier can use the output as a part of managing their computing infrastructure. A person that works for the supplier may look at the output and perform management tasks. However, the management, or other processing, may be performed automatically without human intervention based on any one of the input, the parameters, the knobs or the output, or a combination thereof. Therefore, human intervention is not required as a part of using methods and systems, according to various embodiments.

A method is provided, for example, by a system that includes a model of the cloud computing business, a functions component configured for specifying relationships between inputs, parameters, knobs and outputs associated with the model, and a loop component for creating output by performing the functions, as will become more evident.

As discussed herein, a supplier of computing infrastructure uses a model as a part of managing computing infrastructure for rent to business users, among other things. The model, for example, drives the purchase and operation of the infrastructure and services, given an amount and mix of use.

The model, for example, includes data specifying inputs, parameters, knobs, and output. The inputs are related to demand and cost, among other things, and the outputs are related to profitability, for example. The inputs can vary, for example, over time. The model of the cloud computing business receives inputs, for example, in the form of demand and cost, parameters or knobs, among other things, and models the output, for example, based on the inputs, knobs or parameters.

Examples of inputs are demand and cost, which can be varied. The knobs represent things, for example, that the supplier has control over, whereas, the parameters, for example, represent things the supplier does not have control over. The parameters may change less frequently than the knobs, as will become more evident.

Examples of costs include, but are not limited to: the power cost, cost of ramping up, and cost of computing infrastructure, among others.

The parameters can be classified. Table 1 below depicts parameters that have been classified as revenue drivers, for example, and Table 2 depicts parameters that have been classified as cost drivers, for example.

TABLE 1
Example Revenue Parameters

| | |
|---|---|
| Expected demand | Modeled as total anticipated revenue per year |
| Price/VM hour | List price modeled for one size virtual machine |
| | (VM), generalizes to smaller and larger VMs |
| Price/GB stored/ | List price for standard “blob” storage, generalizes |
| month | reliability, block storage |
| Price/GB transf. | List price for transferring a gigabyte (GB) to (and |
| (out, in & out) | optionally from) the internet. |
| Demand split: | Modeled as a revenue split across servers, storage, |
| comp, storage, | bandwidth |
| bandwidth | |
| demand for | Models the “value add” licensed software by |
| software | customers |
| Discount | Expected average discount from list price |
| | (quantity + large customer discounts) |
| Control processing | CPUs get faster, improvement transfers to customer |
| unit (CPU) | as reduced price |
| price erosion | |
| Storage price | Price erosion: increased disk capacity transfers to |
| erosion | customer as reduced price |

TABLE 2
Examples of Cost parameters

| | |
|---|---|
| R&D Costs | Fixed development costs at the beginning, followed by a |
| | % of revenue |
| Service | A % of revenue |
| Delivery | |
| Costs | |
| Server | Average % of server capacity rented. (A fully utilized |
| Utilization | server may still not be rented) |
| Server | Threads per Server; models the improvement of servers |
| improvements | over time |
| Storage | Disk Capacity; models the improvement of storage over |
| improvements | time |
| Storage | Expansion of customer data to storage, will fall due to |
| Replication | software improvements |
| Bandwidth | Burstable billing rate for internet bandwidth |
| Costs | |
| Power | $ Per-watt to information technology (IT) gear per month |
| Real-estate | $ Per-user (per-u) rent per month |
| Repair | AFR and replacement cost of gear |
| Overhead | A fraction of power costs; covers the maintenance of the |
| | datacenter proper |

The model, for example, distills data center metrics to cost-per-rack-unit-per-month, cost-per-watt-delivered-per-month and bandwidth charges. Bin-packing can then be used to model the mapping of virtual guests to physical servers. Creating the model, according to one embodiment, exposed several tunable parameters, and what-if scenarios were evaluated to pick appropriate values, such as the percentage of demand for compute, storage and bandwidth.

For selected parameter values, the model, for example, indicates the business profitability, with revenues attributed to storage and compute, with projected growth rates and capital investment for the cost breakdown and the cash flows. Knobs and parameters can be used to influence inputs, for example, by shaping the demand using pricing models, or by directly influencing the costs of running a business, for example, and indirectly they influence the revenue, for example, as will become more evident.

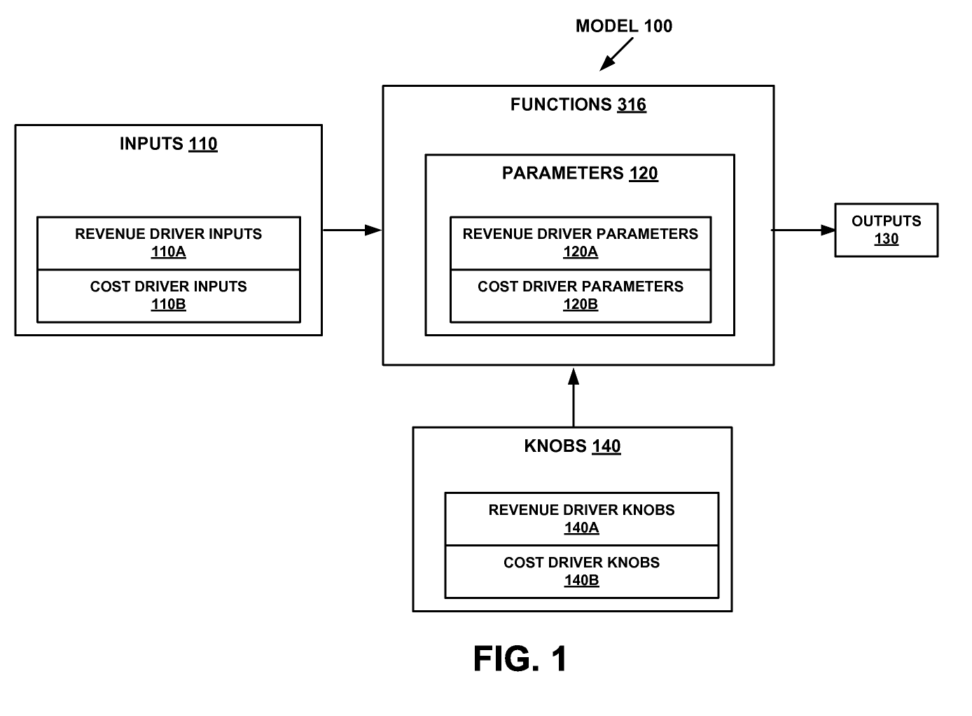

FIG. 1 is a block diagram of a model 100, according to one embodiment. The model 100 includes data describing inputs 110, parameters 120, knobs 140, and outputs 130, among other things, for example. The parameters 120 can be a part of functions. The functions can receive inputs 110 and knobs 140 and create outputs 130 based on the parameters. The inputs 110, parameters 120, and knobs 140 can each be divided into revenue drivers and cost drivers. More specifically, there are revenue driver inputs 110A, cost driver inputs 1108, revenue driver parameters 120A, cost driver parameters 120B, revenue driver knobs 140A, and cost driver knobs 140B, which are depicted in Tables 3-5 as follows.

Table 3a: Examples of revenue driver inputs 110A

demand distribution (growth rate)
demand mix (large, small medium)
demand mix (% compute, store BW)
demand mix (demand, reserve, spot,
hpc)
demand mix (% windows, SQL)

Table 3b: Examples of cost driver inputs 110B

OPEX management adjustment
research and development (R&D)
service delivery
Software licenses
Industry Standard Servers (ISS) gross
margin

Table 4a: Examples of revenue driver parameters 120A

prices (size, model 100)
central processing unit (CPU cores
increase
disk capacity increase

Table 4b: Examples of cost driver parameters 120B

property tax
sales tax due to purchasing hardware
Corporate overhead
Cores or servers, or both
disk capacity
BW/Gb/mo 95^{th}% ile
price per unit earnings (PUE)
overhead other than DC/W/mo
royalty % windows
royalty % SQL
utility charge
per-watt charge
per-use charge

Table 5a: Examples of revenue driver knobs 140A

discount
S&M incentives
utilization (before scale-up)
refresh rate
Preferential pricing (VM, model 100 . . . )

Table 5b: Examples of cost driver knobs 140B

storage replication
over-capacity

Table 6 depicts examples of outputs 130 of the model 100 depicted in FIG. 1, according to various embodiments.

Total revenue
Revenue per virtual hour
Storage revenue, for example, in terms of gigabytes (GB) per month
BW revenue (GB-out)
Break down in terms of comp/store/BW

According to one embodiment, the parameters 120 change less frequently than the knobs 140. For example, the number of CPUs or the property tax may change slowly. Further, the supplier of the computing infrastructure may not have control over the property tax as well as the number of CPU cores associated with a model of hardware. However, the supplier could have control over discounts and incentives, for example. Further, the supplier could probably modify the discounts and incentives more often than the property tax would be changed, for example.

The model 100, for example, may include functionality such as a dashboard, a simulator, or an analysis component that determines what might happen based on inputs 110, parameters 120, or knobs 140, or a combination thereof.

A cloud business, such as the supplier's business, depends on the demand of the cloud users, such as the cloud computing business users, and the cost to run the cloud, which results in some revenue for the cloud stake holders, for example. The cloud user's demand shall also be referred to as revenue drivers and the cost to run the cloud shall also be referred to as cost drivers. An example of a cloud business is the supplier's business. An example of cloud users is the cloud computing business users. An example of cloud stakeholders is a supplier of the computing infrastructure.

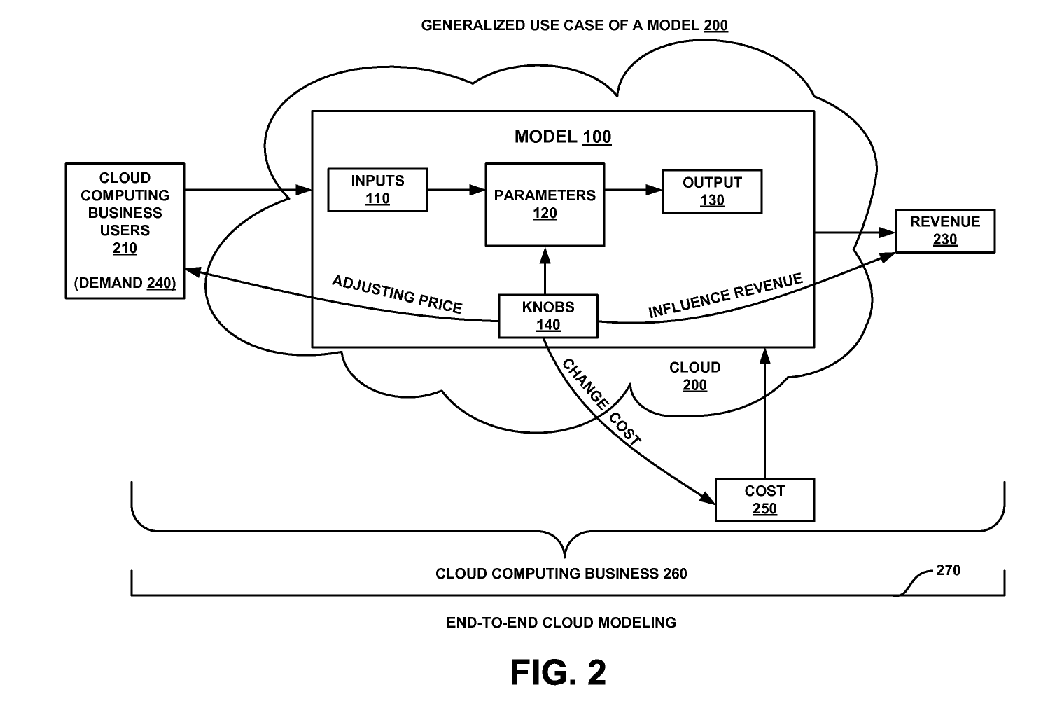

FIG. 2 is a block diagram depicting a generalized use case 200 of the model 100, according to one embodiment. The generalized use case 200 of the model 100 depicts cloud computing business users 210 that provide demand 240, a model 100, inputs 110 to the model 100, parameters 120 for the model 100, knobs 140 of the model 100, outputs 130 of the model 100, another input 110, such as cost 250 to run the suppliers' computing infrastructure, outputs 130 that can be used to determine revenue 230. The model 100 of the cloud computing business receives inputs 110, for example, in the form of demand 240 from the business users 210 and cost 250, parameters 120 and knobs 140, and models the output 130 based on the inputs 110, knobs 140 and parameters 120, for example. The inputs 110 can be varied. The knobs 140 can be used to influence demand 240, cost 250, and revenue 230. The demand 240 can be influenced, for example, through pricing, and the cost 250 can be influenced, for example, through choices, among other things.

The generalized use case 200 is for a cloud computing business 260 that is modeled from end to end as indicated by the line 270 with arrows, for example. The model 100, the outputs 130, and the revenue 230, are associated with a supplier of computing infrastructure.

As can be seen in FIG. 2, knobs 140 and parameters 120 can be used to influence inputs 110, for example, by shaping the demand 240 using models 100 for pricing, or by directly influencing the costs 250 of running a business, for example, and indirectly they influence the revenue 230, for example, according to various embodiments.

Any combination of the demand 240 and the cost 250 can be simulated or actual. For example, a more specific use case can be determined based on the generalized use case 200 using simulated or actual demands 240 and costs 250 and the associated output 130 as indicated below. Different combinations of real or simulated demand 240 and cost 250 can result in different output 130, for example, as depicted below:
1) the output 130 may be procurement business analysis when using simulated demand 240 and simulated cost 250,
2) the output 130 may be business planning when using simulated demand 240 and actual cost 250,
3) the output 130 may be technology refresh planning when using actual demand 240 and simulated cost 250, and
4) the output 130 may be runtime management when using actual demand 240 and actual cost 250.

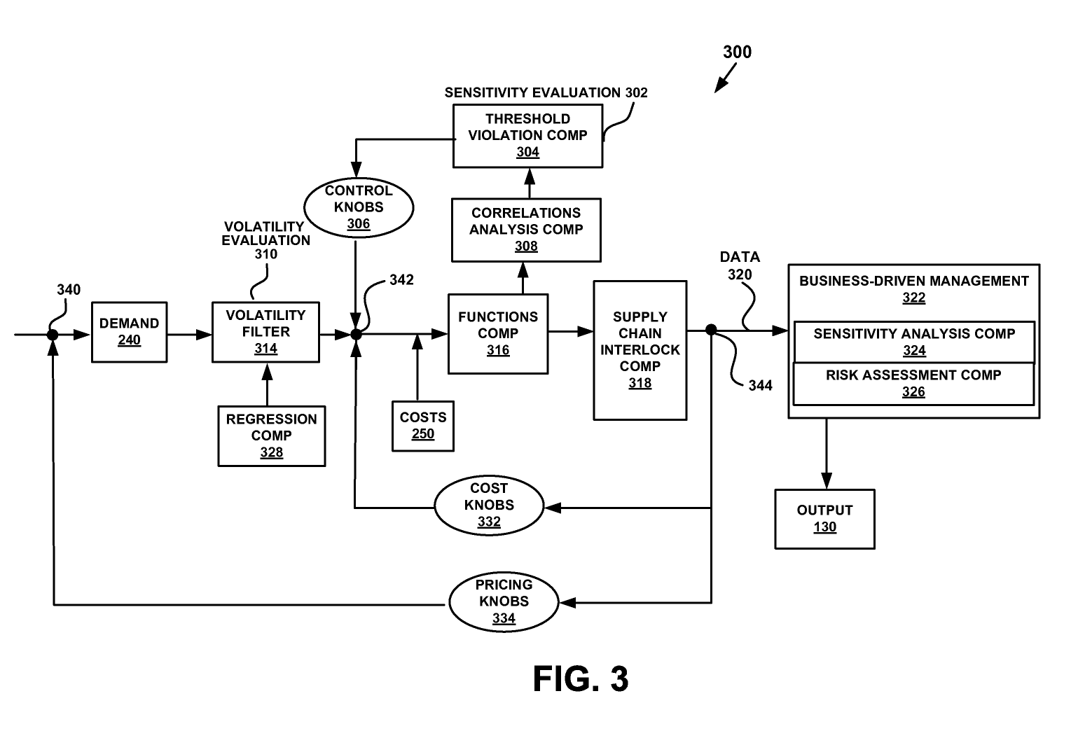

FIG. 3 is a block diagram of a system 300 that enables a supplier of computing infrastructure to analyze an aspect of business with respect to cloud computing business users of the computing infrastructure, according to one embodiment.

The system 300 includes a volatility filter 314 as a part of volatility evaluation 310, a regression component 328, a functions component 316, correlation analysis component 308, threshold violation component 304 as a part of sensitivity evaluation 302, a supply chain interlock component 318, a business-driven management component 322, control knobs 306, cost knobs 332, pricing knobs 334, and three closed loops. The business-driven management component 322 includes a sensitivity analysis component 324 and a risk assessment component 326.

Inputs 110 (FIG. 1) can be received as demand 240 or cost 250, or a combination thereof, for example. The demand 240 may be IaaS demand and the cost 250 may be IaaS cost.

A validity evaluation 310 can be performed. The demand inputs 240 can be filtered for volatility. The regression component 328 can perform regression to determine if the volatility is fixed, relative or seasonal. More specifically, a determination can be made as to whether the volatility occurs at fixed periods of time, whether the volatility is relative, whether the volatility is seasonal in nature, such as at Christmas time, among others.

Referring to FIGS. 1 and 3, the supplier can adjust the knobs 140. As depicted in FIG. 3, there are three types of knobs 140, according to one embodiment. The depicted three types of knobs 140 include cost knobs 332, pricing knobs 334, and control knobs 306, for example. According to various embodiments, examples of cost knobs 332 are storage replication and over capacity, examples of pricing knobs 334 are discount, incentives, preferential pricing, and any of the knobs 140 depicted in FIG. 1 could be examples of control knobs 306.

The subset of inputs 110 that result from the volatility filter 314 can be received by the model 100s' functions component 316 where the inputs 110 are processed in combination with parameters 120 based on, for example, the knobs 140.

There are also closed loops that perform additional processing, according to various embodiments. For example, there is a closed loop associated with each type of knobs 140. In a specific example, there is a closed loop for the pricing knobs 334 that flows, for example, from the left of the pricing knobs 334, to point 340, through demand 240, volatility filter 314, functions component 316, supply chain interlock component 318, to point 344, then back to the right side of the pricing knobs 334. There is, for example, a closed loop for the cost knobs 332 that flows, for example, from the left of the cost knobs 332 to the point 342, through the functions component 316, the supply chain interlock component 318, to point 344, then to the right of cost knobs 332. There is, for example, another closed loop for the control knobs 306 that flows, for example, from the bottom of the control knobs 306 to point 342, through the functions component 316, the correlation analysis component 308, the threshold violation component 304, and then to the top of the control knobs 306.

Intermediate data can result from the functions 316 and the closed loops processing of inputs 110 based on parameters 120, for example. The functions 316 and the closed loops can process the intermediate data resulting in further intermediate data for the iterations of the loops, for example.

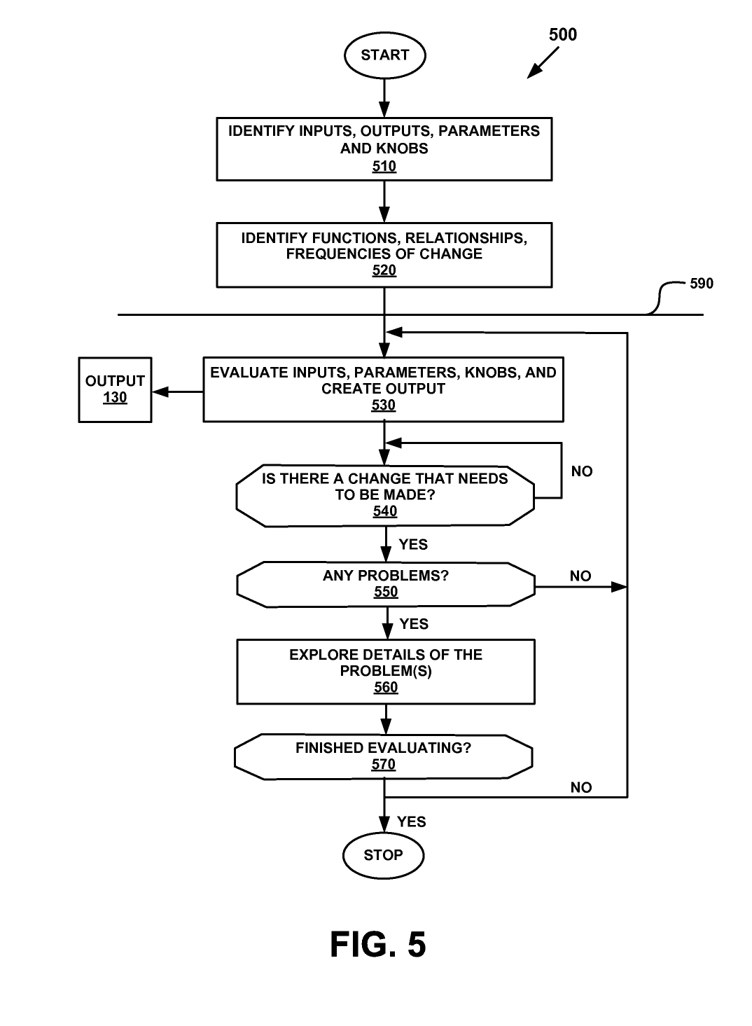

As a part of processing associated with the closed loops, supply chain interlock can be performed by the supply chain interlock component 318 and correlation analysis can be performed by the correlation analysis component 308. The threshold violation component 304 can determine if any thresholds have been violated. FIG. 5 also uses thresholds at 550 as a part of determining if there are any problems, according to various embodiments, as will become more evident. The thresholds can be determined by the supplier, for example, as discussed herein.

Still referring to FIGS. 1 and 3, the system 300 depicted in FIG. 3 includes volatility evaluation 310 and sensitivity evaluation 302. Sensitivity can be tied to inner models, for example, and volatility can be tied to input 110, such as demand 240, for example. For example, referring to FIG. 1, if the inputs 110 are changed, there can be a large change in the values provided by the model 100 because the values provided by the model 100 may depend on multiplying the inputs 110 by large numbers. In contrast, sensitivity determines, for example, the rate of change or dependencies of the inner models on the changes in the inputs 110.

The threshold violation component 304 can perform sensitivity evaluation 302 on variable pairs such as the inputs 110, parameters 120, knobs 140, among others, for example. The sensitivity evaluation 302 can be performed on all variable pairs that pertain to the desired processing.

When the processing associated with the three closed loops is complete, data 320 that resulted from the system 300's processing, can be supplied to the business-driven management component 322. The business-driven management component 322, for example, includes a sensitivity analysis component 324 and a risk assessment component 326 that may perform sensitivity analysis and risk assessment respectively. The business driven management component 322 can provide, for example, for managing carbon offsets from financials, business alerts, and demand 240 forecast procurement of ordering, among other things.

FIG. 3 depicts three closed loops that can be used as a part of the loop component, according to various embodiments. FIG. 3 depicts functions that can be used as a part of a function component 316, according to various embodiments.

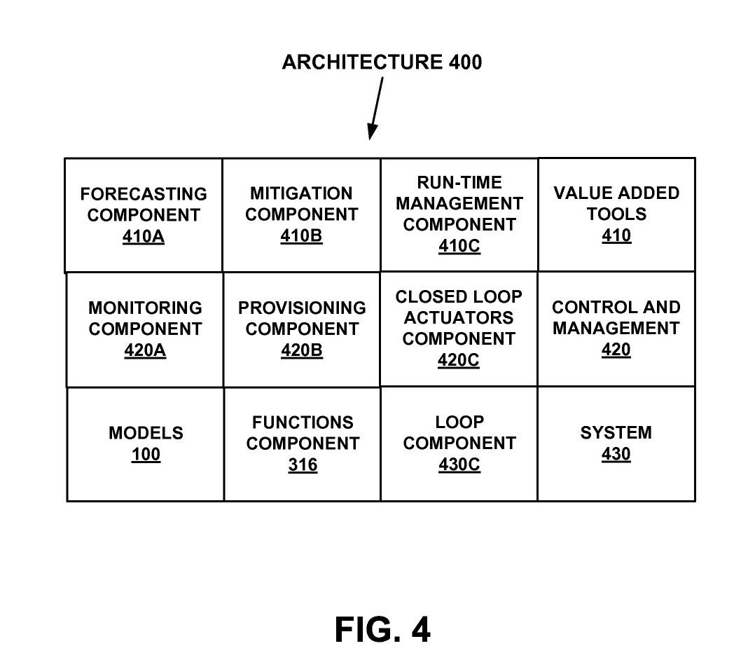

FIG. 4 is a block diagram of a cloud computing business architecture 400 that includes a system 430 that enables a supplier of computing infrastructure to analyze an aspect of business with respect to cloud computing business users of the computing infrastructure, according to one embodiment.

Referring to FIGS. 1 and 4, the system 430 includes a model 100, a functions component 316, and a loop component 430C, for example. The model 100 is of a cloud computing business for the business users to rent computing items of the computing infrastructure from the supplier. The model 100 specifies inputs 110, parameters 120, knobs 140, and outputs 130. The supplier has control over the knobs 140. The functions component 316 is configured for specifying relationships between at least a subset of the inputs 110, the parameters 120, the knobs 140, and the outputs 130. The loop component 430C is configured with loops, as discussed herein, for creating an output by performing functions on an input based on a parameter and a knob.

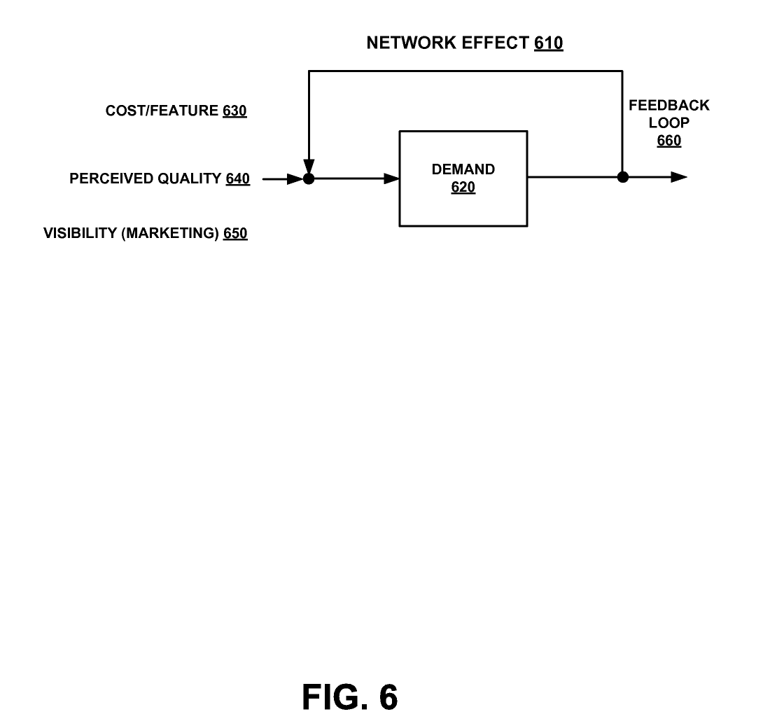

An example of the model 100 is depicted in FIG. 1. An example of the functions component 316 is depicted in FIG. 3. Examples of loops that the loop component 430C can be configured with are depicted in FIG. 3 and FIG. 6. More specifically, the loop component 430C can be configured with any of the closed loops associated with the control knobs 306, the cost knobs 332 or the pricing knobs 334, or a combination there of, among others, as discussed herein.

The cloud computing business architecture 400 may include two other layers—value added tools 410 and controls and management 420—that use the system 430, for example.

As depicted, the control and management layer 420 includes components for monitoring 420A, provisioning 420B, and closed loop actuators 420C. Monitoring and provisioning are discussed herein, for example, at least in the context of Table 8. Closed loop actuators 420C can be either software (machine readable instructions) or hardware, or a combination thereof, which will provide change in an input 110 (FIG. 1). For example, the actuators can be used to turn a machine on, turn a machine off, cause a resource to be provisioned, among other things.

According to one embodiment, the provisioning component 420B can be used for provisioning and re-provisioning computing items of the computing infrastructure that are rented to business users. For example, the rented computing items can be provisioned to a first business user for a period of time. When the first business user is done with those computing items, the computing items can be returned to an available pool and then later be re-provisioned, for example, to a second business user for a second period of time.

Referring to FIGS. 1 and 4, the value added tools layer 410 includes components for forecasting 410A, mitigation 4108 and run-time management 410C, for example. Forecasting and mitigation are discussed herein, for example, at least in the context of Table 8. Run-time management component 410C can be software that implements the closed loops, as discussed herein. Real-time management of the cloud computing business can be performed using any one of the knobs 140, or a combination of the knobs, among other things. For example, the management can be affected by a change in any one of the knobs 140.

According to one embodiment, a system 430 (FIGS. 3 and 4) provides sufficient automation in order to optimize for the supplier's goals. Examples of goals are depicted in Table 8, as described herein.

Referring to FIGS. 1, 3 and 4, a system 300, 430 (FIGS. 3 and 4) can include a dashboard that a person can use to change knobs 140, parameters 120, inputs 110, or visualize output 130, or a combination thereof, among other things. The output 130 enables a person to visualize the impact and evaluate how the model 100 is changing, for example. Therefore, a dashboard can be used for obtaining insight into the cloud computing business by performing simulation and trending.

The blocks that represent features in FIGS. 3 and 4 can be arranged differently than as illustrated, and can implement additional or fewer features than what are described herein. Further, the features represented by the blocks in FIGS. 3 and 4 can be combined in various ways. The systems depicted in FIGS. 3 and 4 can be implemented using hardware, hardware and software, hardware and firmware, or a combination thereof.

According to one embodiment, a method and a system that enables a supplier of computing infrastructure to analyze an aspect of business with respect to cloud computing business users is provided. Examples of an aspect of business include, but are not limited to, demand, price, cost, revenue, infrastructure, quality, sustainability, and profitability.

Examples of provided analysis include the sensitivity analysis and risk assessment.

Other examples of provided analysis include, among other things, any of the following:

Analyzing impact of pricing, for example, of individual types using pricing knobs 334, as depicted in FIG. 3:
Impact of different size and features of guest VMs,
Impact of different availability model 100s of guest VMs, such as, spot verses on demand verses reserved.

Costs using cost knobs 332, as depicted in FIG. 3,
Support, R&D, infrastructure costs (storage, servers, building, electricity, property tax), bandwidth, etc.,
Analyze the costs and value of businesses layered on top of the infrastructure as a service (IaaS), platform as a service (PaaS) and software as a service (SaaS),
Data center and sustainability: analyzing infrastructure costs (financial and environmental) for deriving sustainability indices, including an analysis of multiple power sources.

Business driven management 322 as depicted by in FIG. 3,
Provisioning infrastructure to maximize return on investment (ROI) and growth given a demand curve, for example, in terms of cash flow, profit and loss, volatility,
Managing carbon offsets from financials, such as, split with customers, retain, or transfer to customer,
Aging out and replacement strategies for infrastructure. maximizing extracted value from infrastructure, such as, aging out hardware when there is no longer a marginal return,

Volatility and occupancy studies to model 100 realistic demand (seasonal, relative and absolute, and random changes). Ensuring sufficient infrastructure in the face of volatility, but optimized to tradeoff cost of denied service against over-provisioning, as depicted by the regression component 328 in FIG. 3,
Monte Carlo simulation of the demand, such as a work load, to complement the real-time data,

Sensitivity, analytics of monitored data to detect trends and refine control loops as depicted by the correlation analysis component 308 in FIG. 3.

The impact of a new technology on the model 100 (FIG. 1) can be evaluated. For example, the impact of the new technology can be evaluated by changing parameters 120 (FIG. 1) for prices, CPU, disk capacity, among other things. Further, the impact of the new technology can be evaluated by changing pricing knobs 334 (FIG. 3). For example, the supplier can play with providing a discount or an incentive, among other things.

The model 100 (FIG. 1), for example, enables the supplier's business to determine how to handle technology refreshes, which can erode the value of deployed servers and storage, as well as competitive pressures.

Energy cost is another example of an aspect of business. According to one embodiment, current energy costs and projected energy costs can be evaluated and set forward spot market pricing can be provided based on the evaluating. For example, the evaluation can be based on a parameter for current energy costs, for example, for the region where the supplier receives their electricity and an input could be for the current cost from that region. Then forward spot market pricing can be performed based on the evaluation.

| IaaS | IaaS Goals | | |
|---|---|---|---|
| Functions | Quality | Sustainability | Profitability |
| Forecasting | Predict demand | Predict impact on | Predict profitability |
| | and its impact on | Sustainability by | as a function of |
| | Quality of service | most relevant | most relevant |
| | as a function of | factors | parameters 120 |
| | different trends | | |
| Mitigation | Maximize quality | Mitigate influence | Mitigate the |
| | of service (QoS) | of various factors, | factors that can |
| | in face of | both short and | negatively impact |
| | demand. Shape | long-term on the | profitability of |
| | procurement, | sustainability of | IaaS business |
| | pricing, etc | IaaS business | |
| | (typically using | | |
| | knobs 140 to | | |
| | accomplish QoS | | |
| | targets) | | |
| Monitoring | Continuously | Continuously | Continuously |
| for goals | monitor for QoS | monitor for | monitor for |
| | of services, such | sustainability | profitability of |
| | as time to | (e.g. economic, | IaaS (profit, |
| | provision, | ecological, social | revenue, cost, |
| | networking | implications, | discounts, pricing |
| | traffic, failures, | exargy, etc.) | model 100s, etc.) |
| | etc. | | |
| Service | Optimize quality | Provisioning for | Provisioning for |
| provisioning | of user services | maximized | maximized profit |
| | | sustainability | |

Table 8 depicts three columns for goals, four rows for functions and a cell where each column and function intersect, according to various embodiments. Therefore, each function can be used as a part of achieving any of the goals, according to various embodiments. Each cell describes how to use an associated function to achieve an associated goal, according to various embodiments.

Quality can pertain to the business user's perception of the quality the supplier is providing to them. Sustainability can pertain to the use of the earth's resources. For example, how much carbon dioxide is being produced? Sustainability, for example, may be poor if the resources are turned on but not being used. Profitability can pertain to how much money the supplier is making.

The forecasting function can be used as a part of predicting quality, sustainability and profitability. For example, different trends and parameters 120 (FIG. 1) can be used as a part of forecasting. In a specific example, pricing knobs 334 (FIG. 3) can be used to impact demand. If the price is reduced, the demand 240 (FIGS. 2 and 3) may go up, for example.

The mitigation function can be used as a part of mitigating reduced quality, mitigating poor sustainability or mitigating low profitability, or a combination thereof. Once something has been forecasted, the system 300, 430 (FIGS. 3 and 4) can be used to experiment with it. For example, how can low quality be mitigated? Mitigating can be used in determining what to do to make things change.

The monitoring function can be used for monitoring whether the supplier is achieving any of their goals, such as quality, sustainability and profitability.

The service provisioning function can be used for provisioning resources in order to achieve any of the goals.

Any of the goals—quality, sustainability, and profitability—may be an aspect of a business that can be analyzed.

Referring to FIGS. 1 and 3, according to one embodiment, a functions component 316 is configured for specifying relationships between at least a subset of the inputs 110, the parameters 120, the knobs 140, and the outputs 130. The relationships can be expressed in terms of mathematical statistical relationships, tables, among other things.

In one example of a function, if there are four cores per central processing unit (CPU), then a vm-per-core can be determined with an associated typical cost per CPU, which is expressed in terms of capital operation expenses. Then one can derive the cost and suggest prices for certain overhead. For larger virtual machines (VMs), corresponding parameters 120 (FIG. 1) that are proportional to smaller parameters 120 (FIG. 1) can be used.

In another example of a function, cost is a function of capital expense, which is a part of trending building, electricity, support, among other things.

In yet another example of a function, quality of service as a part of a subset of parameters 120 in terms of expectations for certain percentage of time or a certain CPU amounts, or a combination there of.

The forecasting, mitigation, monitoring, and service provisioning depicted in Table 8 are examples of functions that can be used as a part of the functions component 316 (FIGS. 3 and 4).

FIG. 5 depicts a flow chart 500 for a number of uses of the system 300, 430 (FIGS. 3 and 4), according to one embodiment.

According to one embodiment, the flow chart 500 is divided, as indicated by the line 590, into a portion that can be performed by a human and a portion that can be performed automatically. For example, the flow chart 500 can be performed by a human at 510 and 520. However, the flow chart 500 can be performed automatically, for example, by one or more computing systems, at 530-570, for example. The second portion below line 590 includes an example of a closed loop that can be implemented using a loop component 430C (FIG. 4).

At 510, referring to FIG. 1, inputs 110, outputs 130, parameters 120 and knobs 140 can be identified by a human, for example. Tables 1-6 depict examples of inputs 110, outputs 130, parameters 120 and knobs 140 that a human can identify, according to various embodiments. A supplier may select all or a subset of the inputs 110, outputs 130, parameters 120, and knobs 140 depicted in Tables 1-6, for example, according to various embodiments, for implementation in a model 100. The human can select, for example, the knobs 140 based on their impact on revenue for the supplier's business.

At 520, functions, relationships, frequencies of changes can be identified by a human. Various examples of functions are described herein.

At 590, referring to FIG. 1, the inputs 110, parameters 120, and knobs 140 can be evaluated and output 130 can be created. Examples of output 130 are provided in table 6.

At 540, a determination is made as to whether a change is needed to be made, according to one embodiment. If a change is needed, processing can proceed to 550. If not processing can return to 540. An example of determining if a change is needed is determining whether a change needed in order to change the demand 240 (FIG. 2).

At 550, a determination can be made as to whether there are any problems. If there are no problems, processing can return to 530. An example of a problem is a drop in revenue. The supplier can provide thresholds for the determination of problems. More specifically, the supplier could provide a revenue threshold where revenue is considered to be acceptable above that threshold and not acceptable when it drops below that threshold.

If there are problems, processing can proceed to 560 where the details of the problems can be explored. For example, if the business revenue drops 10 percent, which is another example of a threshold, an alert can be generated. Exploration of the reasons for the drop can be performed at 570. The reasons for the drop may be handled automatically, for example, by the system 300, 430 (FIGS. 3 and 4) or, for example, a person can look at output that describes the alert. For example, actions for provisioning additional resources to address quality of service, building additional infrastructure, turning off machines to address poor sustainability, changing prices to shape demand, among other things, can be performed automatically or a human can determine to take these actions based on the output 130 (FIG. 1). A human or a system 300, 430 (FIGS. 3 and 4) can react to this problem by changing any of the knobs 140 (FIG. 1).

At 570, a determination can be made as to whether evaluation is finished. If evaluation is finished, the processing ends. If not, processing can return to 530.

FIG. 6 depicts an example of a closed loop network effect e.g., peering, according to one embodiment. Various embodiments provide for peering effect, also known as network effect 610. For example, the more cloud computing business users that rent computing infrastructure from a supplier, the more the business users will be able to leverage cost-effective intra-site communication verses incurring cost to go to another supplier. According to one embodiment, this is a feedback loop 660 that influences demand for different investments in cost per feature 630, perceived quality 640 and visibility 650, such as marketing. For example, the more customers, such as cloud computing business users, that a supplier has, the more attractive the supplier becomes to new customers. The network effect 610 can apply to costs or features 630, perceived quality 640, or visibility 650, or a combination thereof, among other things.

Referring to FIG. 1, any of the closed loops can be established, for example, by differentiating parameters 120 and knobs 140 that influence input 110 and output 130. According to one embodiment, the loop in FIG. 5 is an example of a generalized loop. According to one embodiment, the closed loops depicted in FIGS. 3 and 6 are examples of specific loops.

The processing, performed by the architecture 400 (FIG. 4) and below the line 590 in flowchart 500 (FIG. 5), can be performed automatically without human intervention, for example. Therefore, human intervention is not required, for example, to achieve goals as depicted in Table 8, using, for example, functions, such as the components depicted in FIGS. 3 and 4, and Table 8, among others.

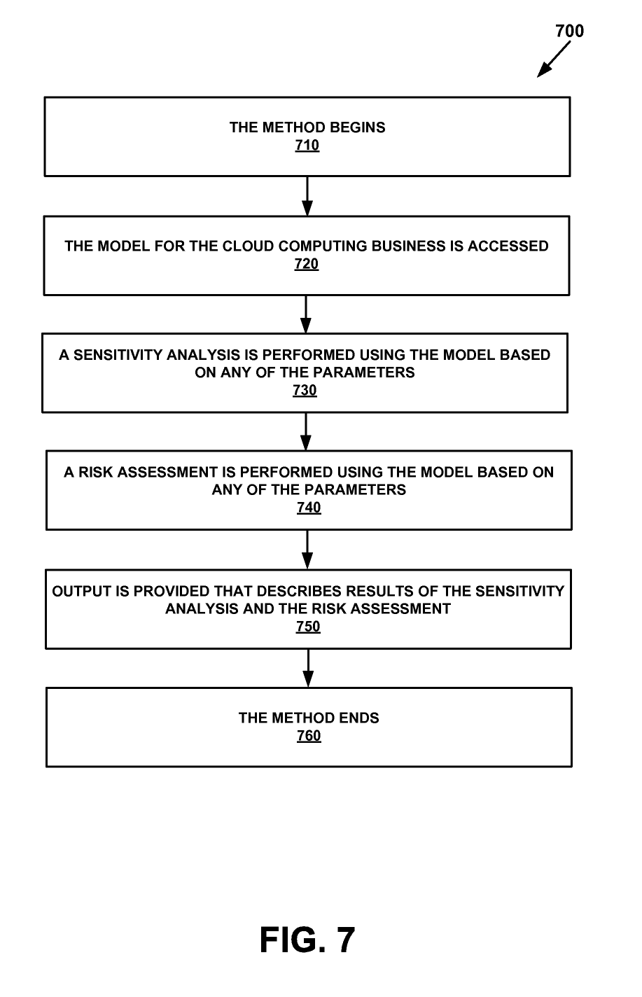

FIG. 7 depicts a flow chart 700 of a method of enabling a supplier of computing infrastructure to analyze an aspect of business with respect to cloud computing business users of the computing infrastructure.

At 710, the method begins.

At 720, referring to FIGS. 1 and 2, the model 100 for the cloud computing business can be accessed. An example of a model 100 is depicted in FIG. 1. The model 100 is of a cloud computing business 260 for cloud computing business users 210 to rent computing items of the computing infrastructure from the supplier. The model 100 includes, for example, inputs 110, parameters 120, knobs 140 and outputs 130 for cost 250, demand 240, pricing, and revenue 230. The supplier has control over the knobs 140.

At 730, referring to FIGS. 1-3, a sensitivity analysis can be performed using the model 100 based on any of the parameters 120 and at 740, a risk assessment can be performed using the model 100 based on any of the parameters 120. For example, inputs 110 in the form of demand 240 and cost 250 can be received. The demand input 240 can be filtered by the volatility filter 314 to model 100 inputs 110 that the supplier cares about, the subset of inputs 110 that result from the volatility filter 314 can be received by the model 100s' functions component 316 where the inputs 110 can be processed based, for example, on knobs 140 and parameters 120.

Referring to FIGS. 1 and 3, there are also closed loops that perform additional processing. For example, a closed loop can be associated with each of the knobs 140. More specifically, there may be a closed loop for the pricing knobs 334, a closed loop for cost knobs 332, and a closed loop for control knobs 306, as discussed herein.

Intermediate data may result from the functions and the closed loops processing of inputs 110 based on parameters 120 and knobs 306, 332, 334. The functions and the closed loops can process the intermediate data resulting in further intermediate data for each of the iterations of any of the loops. When the processing is complete, data 320 may be supplied to the business-driven management component 322 that includes a sensitivity analysis component 324 and a risk assessment component 326 that can perform sensitivity analysis and risk assessment respectively.

At 750, referring to FIGS. 1 and 3, output 130 can be provided that describes results of the sensitivity analysis and the risk assessment. For example, output 130 from the processing of the data 320 by the sensitivity analysis component 324 and the risk assessment component 326 can be provided. Examples of output 130 are depicted in Table 6. Outputs 130 can be provided to a person associated with the supplier in any form that enables the person to visualize the output. For example, outputs 130 can be displayed or printed on paper. Accordingly to another embodiment, architecture 400 (FIG. 4) can use any one of the inputs 110, the output 130, the knobs 140, or the parameters 120, or a combination thereof, automatically, as discussed herein.

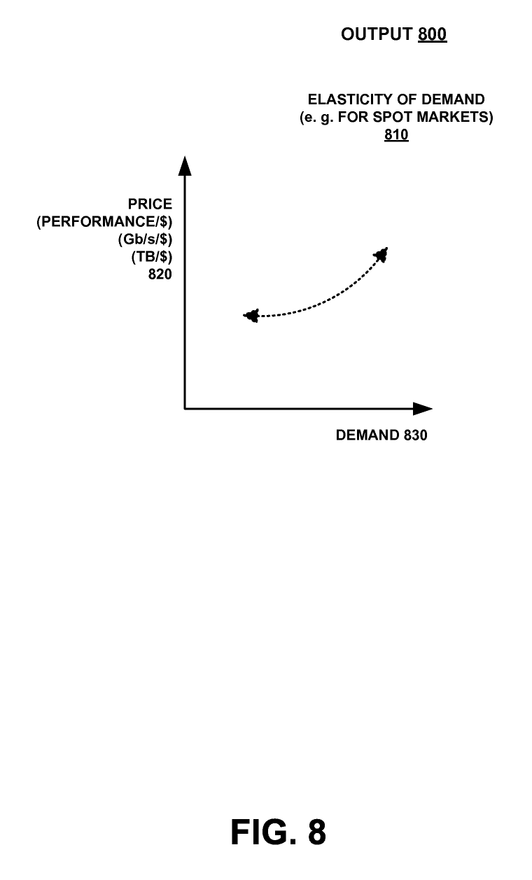

Another example of an output 800 is depicted in FIG. 8, according to one embodiment. FIG. 8 is an example of output 800 in the form of a graph 810. The x axis pertains to demand 830 and the y axis pertains to price 820, for example, in terms of performance, gigabytes, or terabytes, among other things. The graph 810 can be used for evaluating elasticity of demand to enable spot marketing. According to one embodiment, as demand 830 goes up, the infrastructure becomes cheaper. For example, the more infrastructure that the supplier has, the more efficiently that infrastructure can be provided to business users.

Referring to FIG. 1, the output 130 can, for example, enable a person to visualize an impact of a change in any of a knob 140, a parameter 120, an input 110, where the impact may occur any where from a lowest technological level to a highest level business metric associated with the supplier. Examples of lowest technological level pertains to the computing items of the computing infrastructure, such as hardware or software, and highest level business metric includes business driven management, which pertains to pricing and costing of clouds, for example.

According to one embodiment, the computing infrastructure can be managed based on any of the input 110, the output 130, knobs 140, parameters 120, or intermediate data, or a combination thereof. The management of the computing infrastructure, according to one embodiment, is under the control of the supplier, for example, because the supplier controls the system 300, 430 (FIGS. 3 and 4), according to one embodiment. Examples of managing are anticipating timing and demand, provisioning of computing infrastructure, and determining pricing, among other things.

The accessing 720, the performing 730 of the sensitivity analysis, the performing 740 of the risk assessment, and the providing 750 of the output 130 (FIG. 1) can be performed by one or more computer systems.

At 760, the method ends.

Although specific operations are disclosed in flowcharts 500, 700, such operations are exemplary. That is, embodiments of the present invention are well suited to performing various other operations or variations of the operations recited in flowcharts 500, 700. It is appreciated that the operations in flowcharts 500, 700 may be performed in an order different than presented, and that not all of the operations in flowcharts 500, 700 may be performed.

The above illustration is only provided by way of example and not by way of limitation. There are other ways of performing the method described by flowcharts 500, 700.

According to another embodiment, a system 300, 430 (FIGS. 3 and 4) of enabling a supplier of computing infrastructure to analyze an aspect of business with respect to cloud computing business users of the computing infrastructure is provided. The system 300, 430, for example, includes a model 100 accessing component, a sensitivity analysis component 323, a risk assessment component 326, and an output component.

Referring to FIGS. 1-3, the model accessing component is configured for accessing a model 100 for a cloud computing business for the cloud computing business users 210 to rent computing items of the computing infrastructure from the supplier. The model 100 includes, for example, inputs 110, parameters 120, knobs 140 and outputs 130 for cost 250, demand 240, pricing, or revenue 230, or a combination thereof. The supplier can have control over the knobs 140. The sensitivity analysis component 324 may be configured for performing sensitivity analysis using the model 100 based on any of the parameters 120. The risk assessment component 326 may be configured for performing risk assessment using the model 100 based on any of the parameters 120. The output component may be configured for providing output describing results of the sensitivity analysis and the risk assessment. The accessing, the performing of the sensitivity analysis, the performing of the risk assessment, and the providing of the output 130 may be performed by one or more computer systems.

Referring to FIGS. 1 and 2, according to one embodiment, a method is provided that enables a supplier of computing infrastructure to analyze an aspect of business with respect to cloud computing business users 210 of the computing infrastructure. According to one embodiment, a model 100 is accessed. The model 100 can be of a cloud computing business for the cloud computing business users 210 to rent computing items of the computing infrastructure from the supplier. The model 100 can specify inputs 110, parameters 120, knobs 140, or outputs 130, or a combination thereof. The supplier can have control over the knobs 140. Functions, as described herein, can be performed. The functions can specify relationships between at least a subset of the inputs 110, the parameters 120, the knobs 140, and the outputs 130. Loops can be performed for creating an output 130 by performing functions on an input 110 based on a parameter 120 and a knob 140, for example.

Any of the embodiments described herein can be implemented using non-transitory computer readable storage medium and computer-executable instructions which reside, for example, in computer-readable storage medium of a computer system or like device. The non-transitory computer readable storage medium can be any kind of memory that instructions can be stored on. Examples of the non-transitory computer readable storage medium include but are not limited to a disk, a compact disk (CD), a digital versatile device (DVD), read only memory (ROM), flash, and so on. As described above, certain processes and operations of various embodiments of the present invention are realized, in one embodiment, as a series of instructions (e.g., software program) that reside within non-transitory computer readable storage memory of a computer system and are executed by the computer processor of the computer system. When executed, the instructions cause the computer system to implement the functionality of various embodiments of the present invention. According to one embodiment, the non-transitory computer readable storage medium is tangible.

Example embodiments of the subject matter are thus described. Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

Various embodiments have been described in various combinations and illustrations. However, any two or more embodiments or features may be combined. Further, any embodiment or feature may be used separately from any other embodiment or feature. Phrases, such as “an embodiment,” “one embodiment,” among others, used herein, are not necessarily referring to the same embodiment. Features, structures, or characteristics of any embodiment may be combined in any suitable manner with any other features, structures, or characteristics.

What is claimed is:

1. A method of enabling a supplier of computing infrastructure to analyze an aspect of business with respect to cloud computing business users of the computing infrastructure, the method comprising:
accessing a model for a cloud computing business for the cloud computing business users to rent computing items of the computing infrastructure from the supplier, wherein the model includes inputs, parameters, and knobs;
performing sensitivity analysis using the model based on any of the inputs, parameters, and knobs;
performing risk assessment using the model based on any of the inputs, parameters, and knobs; and
providing output describing results of the sensitivity analysis and the risk assessment;
wherein the accessing, the performing of the sensitivity analysis, the performing of the risk assessment, and the providing of the output are performed by one or more computer systems.

2. The method as recited by claim 1, further comprising:
performing simulation and trending based on a dashboard to obtain insight into the cloud computing business.

3. The method as recited by claim 1, wherein the providing of the output further comprises:
enabling a person to visualize an impact of a change in an item selected from a group consisting of the knobs, the parameters, and the inputs, wherein the impact is anywhere from a lowest technological level to a highest level business metric associated with the supplier.

4. The method as recited by claim 1, wherein the method further comprises:
receiving information describing knobs, wherein the knobs were selected based on their impact on revenue.

5. A system that enables a supplier of computing infrastructure to analyze an aspect of business with respect to cloud computing business users of the computing infrastructure, wherein the system comprises a non-transitory computer readable medium storing executable instructions and a computer processor configured to execute the instructions to implement:
a model of a cloud computing business for the cloud computing business users to rent computing items of the computing infrastructure from the supplier, wherein the model specifies inputs, parameters, knobs, and outputs and wherein the supplier has control over the knobs;
a functions component configured for specifying relationships between at least a subset of the inputs, the parameters, the knobs, and the outputs; and
a loop component configured for creating an output by performing functions on an input based on a parameter and a knob.

6. The system of claim 5, wherein the computer processor is configured to execute the instructions to implement:
a business driven management component for evaluating impact of a new technology on the model.

7. The system of claim 5, wherein the computer processor is configured to execute the instructions to implement:
a run time management component for managing, under control of the supplier, the computing infrastructure based on any of the inputs, the outputs, the parameters, the knobs, and intermediate data.

8. The system of claim 5, wherein the model receives information describing the knobs, the knobs being selected based on their impact on revenue.

9. The system of claim 5, wherein the computer processor is configured to execute the instructions to implement:
a real time management component for performing real-time management of the cloud computing business using any of the knobs.

10. A non-transitory computer readable storage medium having computer-executable instructions stored thereon that when executed cause a computer to implement a system for analyzing an aspect of business with respect to cloud computing business users of computing infrastructure, the system comprising:
a model for a cloud computing business for the cloud computing business users to rent computing items of the computing infrastructure from a supplier, wherein the model includes inputs, parameters, and knobs;
an accessing component for performing sensitivity analysis using the model based on any of the inputs, parameters, and knobs; and
a risk assessment component configured for performing risk assessment using the model based on any of the inputs, parameters, and knobs.

11. The non-transitory computer readable storage medium of claim 10, wherein the system further comprises:
a business driven management component for
evaluating current energy costs and projected energy costs, and
providing set forward spot market pricing of the computing infrastructure based on the evaluating.

12. The non-transitory computer readable storage medium of claim 10, wherein the system further comprises a forecasting component for forecasting business goals.

13. The non-transitory computer readable storage medium of claim 10, wherein the system further comprises a mitigation component for mitigating business goals.

14. The non-transitory computer readable storage medium of claim 10, wherein the system further comprises:
a business driven management component for evaluating impact of a new technology on the model.

15. The non-transitory computer readable storage medium of claim 10, wherein the system further comprises:
a run time management component for managing, under control of the supplier, the computing infrastructure based on the output.
